(19) United States
(12) Patent Application Publication
(10) Pub. No.: US 2018/0188571 A1
(43) Pub. Date: Jul. 5, 2018

(54) DISPLAY PANEL, MANUFACTURING METHOD OF THE DISPLAY PANEL AND DISPLAY DEVICE

(71) Applicants: BOE TECHNOLOGY GROUP CO., LTD., Beijing (CN); HEFEI BOE OPTOELECTRONICS TECHNOLOGY CO., LTD., Hefei, Anhui Province (CN)

(72) Inventor: Sheng WANG, Beijing (CN)

(21) Appl. No.: 15/529,896

(22) PCT Filed: Jan. 3, 2017
(86) PCT No.: PCT/CN2017/000023

§ 371 Date: May 25, 2017

(30) Foreign Application Priority Data
Apr. 12, 2016 (CN) 201610223249.8

(51) Int. Cl. G02F 1/1345; G02F 1/1335; G02F 1/1339

(52) U.S. Cl. CPC G02F 1/1345; G02F 1/133516; G02F 1/1339; G02F 1/133512; G02F 2202/22; G02F 2201/123; G02F 2202/28; G02F 2202/16; G02F 2201/121

(57) ABSTRACT

Embodiments of the present disclosure provide a display panel and a manufacturing method thereof as well as a display device. The display panel can comprise: an array substrate comprising a common electrode layer; a color film substrate arranged opposite to the array substrate, the color film substrate comprising a base substrate and a black matrix on a surface of the base substrate opposite to the array substrate; and a sealant arranged between the color film substrate and the array substrate. The array substrate can further comprise an extending portion outside the sealant. A first contact portion for electrical connection with the common electrode layer is arranged on the extending portion, and the black matrix is connected to the first contact portion through a first electrically conductive member.

### RELATED APPLICATIONS

The present application is the U.S. national phase entry of PCT/CN2017/000023, with an international filing date of Jan. 3, 2017, which claims the benefit of Chinese Patent Application No. 201610223249.8, filed Apr. 12, 2016, the entire disclosures of which are incorporated herein by reference.

### TECHNICAL FIELD

The present disclosure relates to display technology, particularly to a display panel and a manufacturing method thereof, as well as a display device comprising the display panel.

### BACKGROUND

With rapid development of electronic devices such as smart mobile phone and tablet computer, people have higher and higher requirement on the characteristics of a display device such as a liquid crystal display device. Generally speaking, the liquid crystal display device comprises a liquid crystal display panel. The display panel generally comprises an array substrate, a color film substrate and a liquid crystal layer arranged between the two substrates. The color film substrate generally comprises a black matrix (BM). However, in some cases, the black matrix may result in undesired effects to the performance of the display device.

### SUMMARY

Therefore, it is desired to provide an improved display panel and a manufacturing method thereof as well as a display device, which can mitigate or avoid one or more of the above problems.

According to an aspect of the present disclosure, a display panel is provided, comprising:

an array substrate comprising a common electrode layer;

a color film substrate arranged opposite to the array substrate, the color film substrate comprising a base substrate and a black matrix on a surface of the base substrate opposite to the array substrate; and

a sealant arranged between the color film substrate and the array substrate.

The array substrate further comprises an extending portion outside the sealant, a first contact portion for electrical connection with the common electrode layer is arranged on the extending portion, and the black matrix is connected to the first contact portion through a first electrically conductive member.

According to an embodiment of the present disclosure, the first electrically conductive member is a silver adhesive.

According to another embodiment, the silver adhesive can be located on the first contact portion, and a distance between a center position of the silver adhesive on the first contact portion and the color film substrate is greater than or equal to a half of a thickness of the color film substrate and less than or equal to the thickness of the color film substrate.

According to another embodiment of the present disclosure, a portion of an edge of the black matrix corresponding to the first contact portion is aligned with an edge of the base substrate above the extending portion.

According to a further embodiment of the present disclosure, the color film substrate further comprises an electrically conductive layer located on a surface of the base substrate away from the array substrate, and the first electrically conductive member is not in contact with the electrically conductive layer.

According to another embodiment, a second contact portion for electrical connection with a ground wire is further arranged on the extending portion, the electrically conductive layer is connected to the second contact portion through a second electrically conductive member, and the second electrically conductive member is not in contact with the black matrix.

According to another embodiment, the second electrically conductive member is a silver adhesive.

According to another embodiment, a portion of an edge of the black matrix corresponding to the second contact portion is closer to the sealant than an edge of the base substrate above the extending portion.

According to another aspect of the present disclosure, a manufacturing method of a display panel is provided, comprising:

forming an array substrate and a color film substrate, wherein the array substrate comprises a common electrode layer and an extending portion, a first contact portion for electrical connection with the common electrode layer is arranged on the extending portion, and the color film substrate comprises a base substrate and a black matrix on a surface of the base substrate;

attaching the color film substrate to the array substrate through a sealant so that the black matrix is opposite to the array substrate and the extending portion is located outside the sealant; and

connecting the black matrix to the first contact portion through a first electrically conductive member.

According to an embodiment of the present disclosure, the first electrically conductive member is a silver adhesive.

According to another embodiment, connecting the black matrix to the first contact portion through the first electrically conductive member comprises: coating the silver adhesive on the first contact portion; and, connecting the black matrix to the first contact portion through flow of the silver adhesive.

According to another embodiment, a distance between a center position of the silver adhesive on the first contact portion and the color film substrate is greater than or equal to a half of a thickness of the color film substrate and less than or equal to the thickness of the color film substrate.

According to another embodiment of the present disclosure, a portion of an edge of the black matrix corresponding to the first contact portion is aligned with an edge of the base substrate above the extending portion.

According to a further embodiment of the present disclosure, the color film substrate further comprises an electrically conductive layer located on a surface of the base substrate away from the array substrate, and the first electrically conductive member is not in contact with the electrically conductive layer.

According to another embodiment, a second contact portion for electrical connection with a ground wire is further arranged on the extending portion. The method further comprises: connecting the electrically conductive layer to the second contact portion through a second electrically conductive member. The second electrically conductive member is not in contact with the black matrix.

According to another embodiment, the second electrically conductive member is a silver adhesive.

According to another embodiment, a portion of an edge of the black matrix corresponding to the second contact portion is closer to the sealant than an edge of the base substrate above the extending portion.

According to a further aspect of the present disclosure, a display device is provided, which can comprise the above display panel.

### BRIEF DESCRIPTION OF THE DRAWINGS

Now, concepts and additional advantages of the present disclosure will be described through non-restrictive embodiments with reference to the drawings.

FIGS. 1A, 1B and FIGS. 1C, 1D show schematic views of two existing display panels respectively;

FIG. 2A shows a microscope photograph of pixels of a full black image in the event that a black matrix is electrified;

FIG. 2B shows an oscilloscope test signal diagram after the black matrix is powered up;

FIG. 3 shows a schematic view of electric field distribution in a display panel;

FIGS. 4A, 4B and 4C show schematic views of a display panel according to an embodiment of the present disclosure;

FIG. 5 shows a schematic view of a manufacturing method of a display panel according to an embodiment of the present disclosure;

FIGS. 6A and 6B show exemplary processes of connecting a black matrix to a first contact portion through a silver adhesive according to an embodiment of the present disclosure; and

FIGS. 7A and 7B show exemplary processes of connecting an electrically conductive layer of a color film substrate to a second contact portion through the silver adhesive according to an embodiment of the present disclosure.

### DETAILED DESCRIPTION OF THE DISCLOSURE

Next, examples of a display panel, a display device and a manufacturing method of the display panel according to embodiments of the present disclosure will be explained by means of illustration with reference to the drawings. The drawings are schematic and are not drawn proportionally, and are only for explaining embodiments of the present disclosure rather than intending to limit a protection scope of the present disclosure.

It should be understood that when it is stated that an element or a layer is “on”, “above”, “over”, “connected to” or “coupled to” another element or layer, it can be directly on, connected to or coupled to the another element or layer, or an inserted element or layer can also exist. On the contrary, when it is stated that an element is “directly on”, “directly connected to” or “directly coupled to” another element or layer, no inserted element or layer exists.

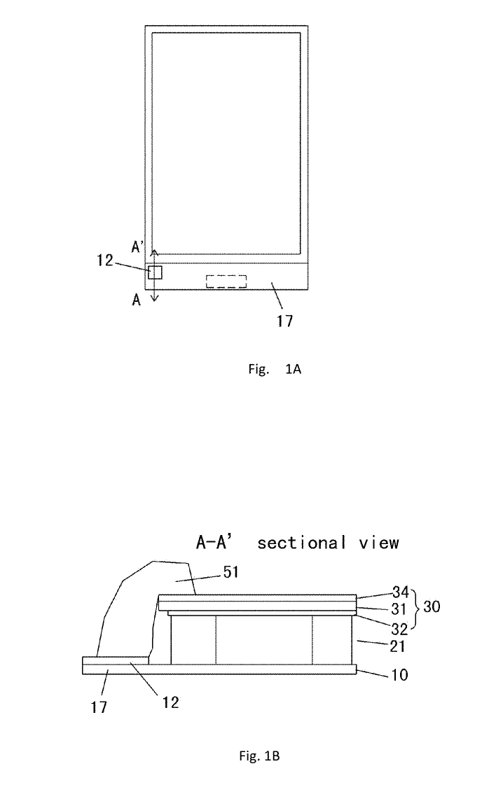

FIGS. 1A, 1B and FIGS. 1C, 1D show the schematic views of two existing display panels respectively.

FIGS. 1A and 1B show a top plan view and a sectional view along a line A-A′ of an existing display panel respectively. As shown in FIGS. 1A and 1B, the display panel comprises an array substrate 10, a color film substrate 30 arranged opposite to the array substrate 10 as well as a liquid crystal layer (not shown) sealed between the color film substrate 30 and the array substrate 10 through a sealant 21. The color film substrate 30 comprises a base substrate 31, a black matrix 32 located on a surface of the base substrate 31 opposite to the array substrate 10 and an electrically conductive layer 34 located on a surface of the base substrate 31 away from the array substrate 10. The electrically conductive layer 34 for example is used for electrostatic discharge (ESD). As shown in FIGS. 1A and 1B, the array substrate further comprises an extending portion 17 outside the sealant 21. A contact portion 12 for electrical connection with the ground wire is arranged on the extending portion 17. The electrically conductive layer 34 is connected to the contact portion 12 through a silver adhesive 51, and the silver adhesive 51 is not in contact with the black matrix 32. In the display panel as shown in FIGS. 1A and 1B, the edge of the black matrix 32 is not aligned with the edge of the base substrate 31 of the color film substrate 30. Compared to the edge of the base substrate 31, the edge of the black matrix 32 is closer to the sealant 21. In such a display panel, although ESD can be realized through the electrically conductive layer 34 that is connected to the contact portion 12 and then is electrically connected with the ground wire, the black matrix 32 may result in problems such as display image defects, as the black matrix 32 possibly carries electrostatic charges.

FIGS. 1C and 1D show a top plan view and a sectional view along a line A-A′ of another existing display panel respectively. The structure of this display panel is substantially the same as the display panel as shown in FIGS. 1A and 1B. The difference lies in that, in the display panel as shown in FIGS. 1C and 1D, the edge of the black matrix 32 is aligned with the edge of the base substrate 31 of the color film substrate 30, i.e., the black matrix 32 is in contact with the silver adhesive 51. In the display panel as shown in FIGS. 1C and 1D, although the black matrix 32 can be electrically connected to the ground wire through contact of the black matrix 32 with the silver adhesive 51 so as to enable the potential of the black matrix to be zero, in such a display panel, flicker phenomenon can be observed, which may influence the quality of the display image.

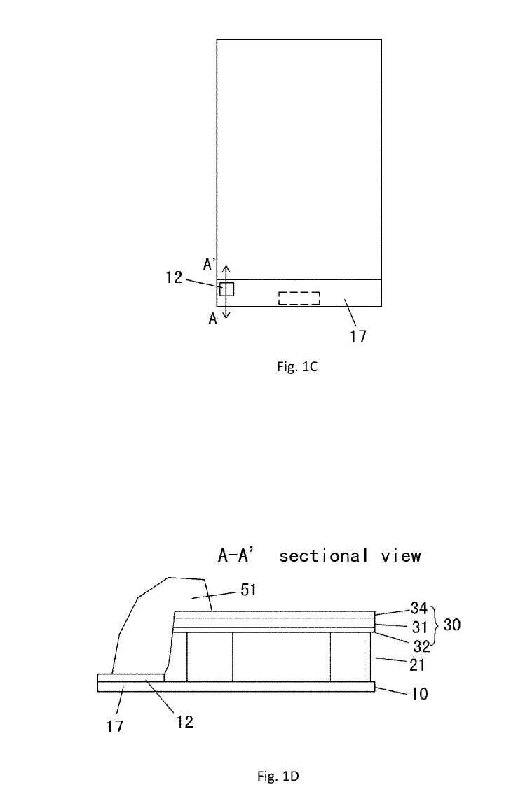

As stated above, in the two existing display panels as shown in FIGS. 1A, 1B and FIGS. 1C, 1D, the black matrix may result in undesired effect to the performance of the display panels. The inventor has recognized this problem and has carried out further studies on this problem. As shown in FIG. 2A, the inventor has captured a microscope photograph of pixels of the display panel in the case of a full black image. From FIG. 2A it can be seen that positions at the peripheral of the pixels are bright. This is caused by an electrified black matrix at the peripheral of the pixels. FIG. 2B shows that, after a certain point of the black matrix is powered up, an oscilloscope test signal diagram is obtained from another point. It can be seen that the black matrix has relatively strong electrical conductivity.

Because the black matrix has certain electrical conductivity and ability of inducing charges, it may possibly result in undesired effect to the performance of the display panel.

More specifically, in the display panel as shown in FIGS. 1A and 1B, although ESD can be realized through the electrically conductive layer 34 that is connected to the contact portion 12 and then is electrically connected with the ground wire, the black matrix 32 will carry electrostatic charges due to its ability of inducing charges, hence, it may result in problems such as display image defects.

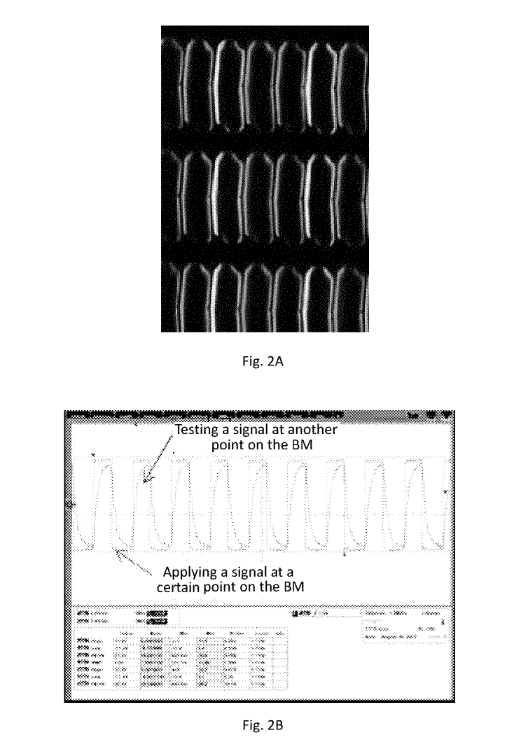

For the flicker phenomenon that occurs in the display panel as shown in FIGS. 1C and 1D, the inventor finds from study that it is caused by abnormal rotation of liquid crystals due to an electric field formed between a black matrix with a zero potential and a pixel electrode and a common electrode of an array substrate. As shown in FIG. 3, the display panel can comprise an array substrate 10 and a color film substrate 30. A liquid crystal layer (not shown in the figure) is arranged between the array substrate 10 and the color film substrate 30. The array substrate 10 for example can comprise a base substrate 11, a gate insulating layer 13, a pixel electrode layer 14, a passivation layer 15 and a common electrode layer 16. The color film substrate 30 for example can comprise a base substrate 31, a black matrix 32, a color filter 33 and an electrically conductive layer 34. The reference sign 22 represents an electric field formed between the common electrode layer and the pixel electrode layer. The reference sign 23 represents an electric field formed between the black matrix and the common electrode layer. The reference sign 24 represents an electric field formed between the black matrix and the pixel electrode layer. For the display panel, when the potential of the black matrix is zero, the electric field formed between it and the electrodes of the array substrate, particularly between it and the common electrode will result in abnormal rotation of the liquid crystals, which results in increase of the flicker. This results in undesired effect to the quality of a display image.

In view of the above problems in the existing display panels, an embodiment of the present disclosure provides an improved display panel.

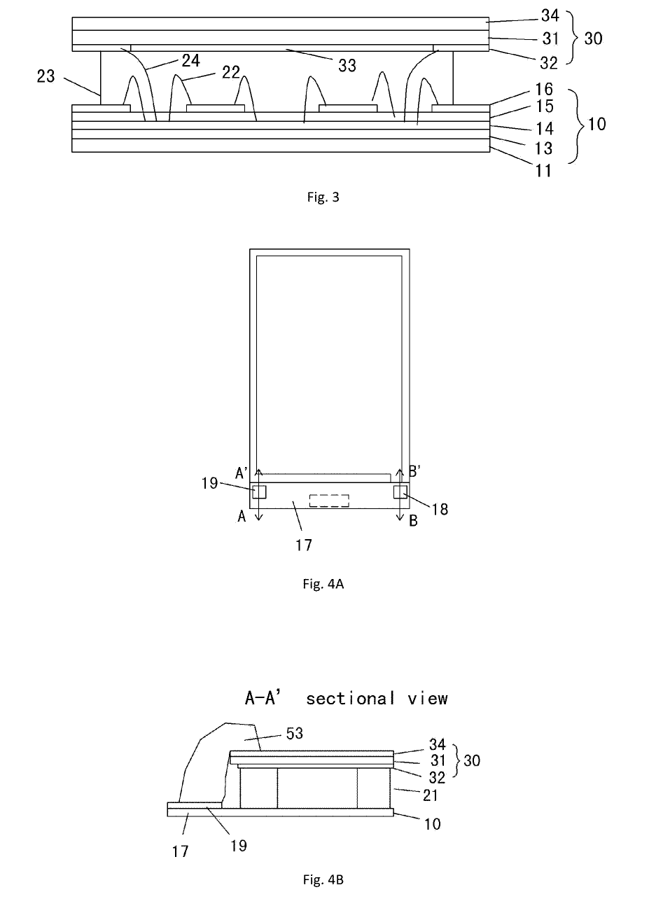

FIGS. 4A, 4B and 4C show schematic views of a display panel according to an embodiment of the present disclosure. FIG. 4A shows a top plan view of a display panel according to an embodiment of the present disclosure. FIGS. 4B and 4C show sectional views of a display panel according to an embodiment of the present disclosure along line A-A′ and line B-B′ respectively.

As shown in the top plan view of FIG. 4A and the sectional view along line B-B′ of FIG. 4C, the display panel according to an embodiment of the present disclosure can comprise: an array substrate 10 comprising a common electrode layer (not shown in the figures); a color film substrate 30 arranged opposite to the array substrate 10, the color film substrate 30 comprising a base substrate 31 and a black matrix 32 on a surface of the base substrate 31 opposite to the array substrate 10; and a sealant 21 arranged between the color film substrate 30 and the array substrate 10. The array substrate 10 can further comprise an extending portion 17 outside the sealant 21. A first contact portion 18 for electrical connection with the common electrode layer is arranged on the extending portion 17, and the black matrix 32 is connected to the first contact portion 18 through a first electrically conductive member 52. In the event that the display panel is a liquid crystal display panel, a liquid crystal layer can be sealed between the color film substrate and the array substrate through the sealant.

In the above display panel, because the black matrix is connected to the first contact portion and then is electrically connected with the common electrode layer through the first electrically conductive member, the potential of the black matrix can be the same as the potential of the common electrode layer. In this way, no electric field will be formed between the black matrix and the common electrode layer, which weakens or eliminates the flicker phenomenon, and improves the quality of a display image.

It should be noted that although not shown in FIGS. 4A-4C, the array substrate 10 can further comprise structures such as a base substrate, a gate insulating layer, a pixel electrode layer, a passivation layer and so on. The color film substrate 30 can further comprise structures such as a color filter etc. Since these structures have been known by the skilled person in the art, they will not be repeated here.

In addition, at the position as shown by a dashed block in the plan view of FIG. 4A, a corresponding integrated circuit can be arranged so as to realize control of the display panel. Since the configuration of the integrated circuit has been known by the skilled person in the art, it will not be repeated here. The first contact portion for example can be connected to the integrated circuit through corresponding wirings.

Optionally, the first electrically conductive member 52 for example can be a silver adhesive. Through forming the first electrically conductive member by the silver adhesive, the above display panel can be manufactured without increasing process complexity to weaken or eliminate the flicker phenomenon. Certainly, the first electrically conductive member can also be formed by other materials or in other manners, as long as it can connect the black matrix to the first contact portion. For example, the first electrically conductive member can be formed by using a metal wire.

According to another embodiment, in the event that the first electrically conductive member 52 is formed by a silver adhesive, the silver adhesive can be located on the first contact portion 18, and a distance between a center position of the silver adhesive on the first contact portion 18 and the color film substrate 30 is greater than or equal to a half of a thickness of the color film substrate 30 and less than or equal to the thickness of the color film substrate 30. By forming the first electrically conductive member using the silver adhesive at an appropriate position, the silver adhesive can be in contact with the black matrix. More specifically, since the distance between the center position of the silver adhesive on the first contact portion and the color film substrate is less than or equal to the thickness of the color film substrate, the silver can be in contact with the black matrix through self-flow of the silver adhesive under gravity. That is, the silver adhesive would not be too far from the color film substrate so as not to be in contact with the black matrix. Moreover, since the distance between the center position of the silver adhesive on the first contact portion and the color film substrate is greater than or equal to a half of the thickness of the color film substrate, an undesired contact between the silver adhesive and other structures (e.g., an electrically conductive layer comprised in the color film substrate stated hereinafter) on the color film substrate can be prevented. That is, the silver adhesive would not be too close to the color film substrate so as to result in undesired contact.

Optionally, a portion of an edge of the black matrix 32 corresponding to the first contact portion 18 for example can be aligned with an edge of the base substrate 31 above the extending portion 17. That is, at the portion of the edge of the black matrix corresponding to the first contact portion, an “alignment” design of the edge of the black matrix and the edge of the base substrate of the color film substrate is realized. Such an “alignment” design is benefit for preventing light leakage.

Optionally, the color film substrate 30 can further comprise an electrically conductive layer 34 located on a surface of the base substrate 31 away from the array substrate 10, and the first electrically conductive member 52 is not in contact with the electrically conductive layer 34. The electrically conductive layer 34 can be used for realizing ESD. By enabling the first electrically conductive member 52 to be in contact with the black matrix 32 while not in contact with the electrically conductive layer 34, an undesired effect to weakening or eliminating of the flicker phenomenon due to electrical connection of the black matrix 32 with the electrically conductive layer 34 through the first electrically conductive member 52 can be prevented.

According to another embodiment, as shown in the top plan view of FIG. 4A and the sectional view along line A-A′ of FIG. 4B, for example, a second contact portion 19 for electrical connection with a ground wire is further arranged on the extending portion 17. The electrically conductive layer 34 is connected to the second contact portion 19 through a second electrically conductive member 53, and the second electrically conductive member 53 is not in contact with the black matrix 32.

By arranging the second contact portion that is electrically connected with the ground wire and connecting the electrically conductive layer to the second contract portion through the second electrically conductive member, the electrically conductive layer can be connected with the ground wire, so as to implement ESD. Meanwhile, because the black matrix is electrically connected with the common electrode layer, the problem that the black matrix carries electrostatic charges in the display panel as shown in FIGS. 1A and 1B can be avoided. Thus, the flicker phenomenon is weakened or eliminated and the quality of the display image is improved while implementing ESD.

According to another embodiment, the second electrically conductive member 53 for example can be a silver adhesive. Through forming the second electrically conductive member by the silver adhesive, the above display panel can be manufactured without increasing process complexity to weaken or eliminate the flicker phenomenon. Certainly, the second electrically conductive member can also be formed by other materials or in other manners, as long as it can connect the electrically conductive layer to the second contact portion. For example, the second electrically conductive member can be formed by using a metal wire.

According to another embodiment, a portion of an edge of the black matrix 32 corresponding to the second contact portion 19 is closer to the sealant 21 than an edge of the base substrate 31 above the extending portion 17. That is, at the portion of the edge of the black matrix corresponding to the second contact portion, a “non-alignment” design of the edge of the black matrix and the edge of the base substrate of the color film substrate is realized. Such a “non-alignment” design is benefit for preventing the black matrix from being in contact with the second electrically conductive member, which avoids an undesired effect to weakening or eliminating of the flicker phenomenon due to electrical connection of the black matrix with the electrically conductive layer.

It should be noted that, although only one first contact portion and one second contact portion are shown in FIGS. 4A-4C, the number of the first contact portion and the number of the second contact portion are not limited to this. The skilled person in the art can set the number of the first contact portion and the number of the second contact portion based on specific applications and/or requirements, and set the number of the first electrically conductive member and the number of the second electrically conductive member correspondingly. In addition, although in FIGS. 4A-4C the shape of the display area of the display panel is a rectangle and the first contact portion and the second contact portion are arranged at outside of the same edge of the rectangular display area and are located at the left and right sides respectively, the shape of the display area and arrangement positions of the first contact portion and the second contact portion are not limited to this. The skilled person in the art can select the shapes of the display area and the display panel on the basis of specific applications and/or requirements, and arrange the first contact portion and the second contact portion correspondingly.

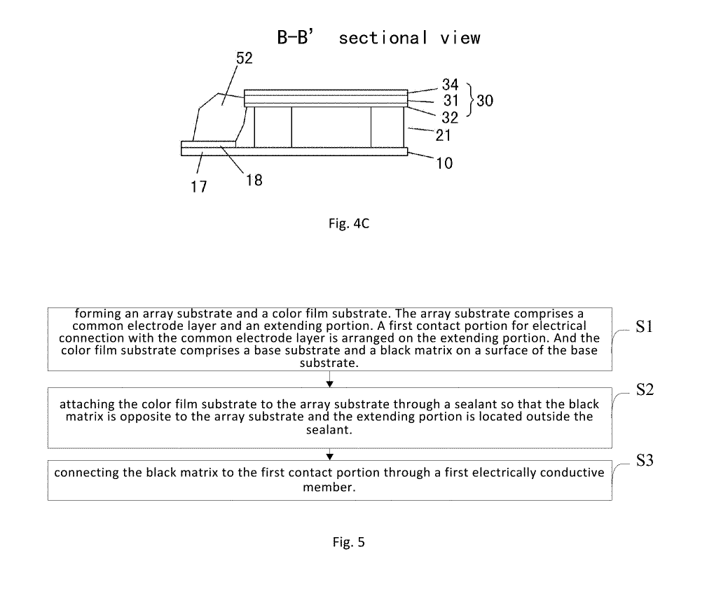

FIG. 5 shows a schematic view of a manufacturing method of a display panel according to an embodiment of the present disclosure.

As shown in FIG. 5, the manufacturing method of a display panel according to an embodiment of the present disclosure comprises the following steps.

S1: forming an array substrate and a color film substrate. The array substrate comprises a common electrode layer and an extending portion. A first contact portion for electrical connection with the common electrode layer is arranged on the extending portion. The color film substrate comprises a base substrate and a black matrix on a surface of the base substrate.

S2: attaching the color film substrate to the array substrate through a sealant so that the black matrix is opposite to the array substrate and the extending portion is located outside the sealant.

S3: connecting the black matrix to the first contact portion through a first electrically conductive member.

In the display panel manufactured by the above method, since the black matrix is connected to the first contact portion through the first electrically conductive member and then is electrically connected with the common electrode layer, the potential of the black matrix can be the same as the potential of the common electrode layer. In this way, no electric field will be formed between the black matrix and the common electrode layer, which weakens or eliminates the flicker phenomenon, and improves the quality of a display image.

As stated above, the array substrate can further comprise structures such as a base substrate, a gate insulating layer, a pixel electrode layer, a passivation layer and so on. The color film substrate can further comprise structures such as a color filter etc. Since these structures have been known by the skilled person in the art, they will not be repeated here.

In an example, the thicknesses of the color film substrate and the array substrate for example can be 200 μm to 1000 μm. After attaching the color film substrate to the array substrate through the sealant, the distance between the color film substrate and the array substrate for example can be 3 μm to 4 μm. The thickness of the black matrix for example can be 0.5 μm to 3 μm.

In addition, regarding the above step S2, in the event that the display panel is a liquid crystal display panel, the color film substrate can be attached to the array substrate using the sealant firstly, and then liquid crystals are injected between the color film substrate and the array substrate. Alternatively, the liquid crystals are coated on the array substrate, the sealant is coated on the color film substrate, and then, the color film substrate is attached to the array substrate and the sealant is cured. Since the process of attaching the color film substrate to the array substrate has been known by the skilled person in the art, it will not be repeated here.

Optionally, the first electrically conductive member for example can be a silver adhesive.

According to another embodiment, in the event that the first electrically conductive member is formed by the silver adhesive, connecting the black matrix to the first contact portion through the first electrically conductive member can comprise: coating the silver adhesive on the first contact portion; and, connecting the black matrix to the first contact portion through flow of the silver adhesive.

According to another embodiment, a distance between a center position of the silver adhesive on the first contact portion and the color film substrate can be greater than or equal to a half of a thickness of the color film substrate and less than or equal to the thickness of the color film substrate.

Optionally, a portion of an edge of the black matrix corresponding to the first contact portion is aligned with an edge of the base substrate above the extending portion.

Optionally, the color film substrate can further comprise an electrically conductive layer located on a surface of the base substrate away from the array substrate, and the first electrically conductive member is not in contact with the electrically conductive layer.

According to another embodiment, a second contact portion for electrical connection with a ground wire is further arranged on the extending portion. The method can further comprise: connecting the electrically conductive layer to the second contact portion through a second electrically conductive member. The second electrically conductive member is not in contact with the black matrix. It should be noted that, the step of connecting the electrically conductive layer to the second contact portion through the second electrically conductive member can be performed simultaneously with the step S3 of connecting the black matrix to the first contact portion through the first electrically conductive member. Alternatively, it can be performed before or after the step S3. The skilled person in the art can select the performing sequence of the two steps based on specific applications and/or requirements.

According to another embodiment, the second electrically conductive member for example can be a silver adhesive.

According to another embodiment, a portion of an edge of the black matrix corresponding to the second contact portion is closer to the sealant than an edge of the base substrate above the extending portion.

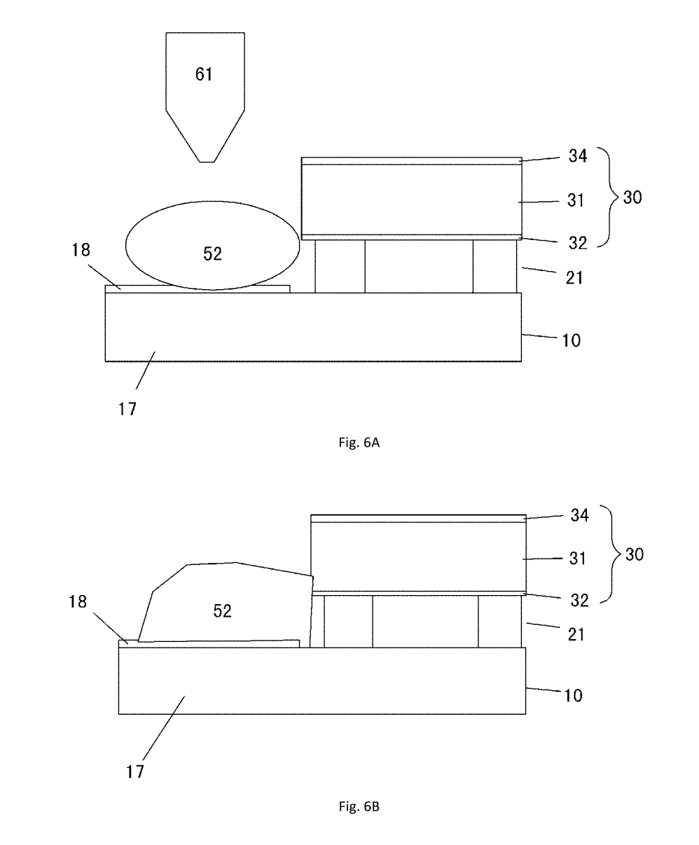

FIGS. 6A and 6B show exemplary processes of connecting the black matrix to the first contact portion through the first electrically conductive member formed of a silver adhesive according to an embodiment of the present disclosure.

As shown in FIG. 6A, the silver adhesive 52 is coated on the first contact portion 18 of the array substrate 10.

As shown in FIG. 6B, the black matrix 32 is connected to the first contact portion 18 through self-flow of the silver adhesive 52 under gravity. In the event that the color film substrate 30 comprises an electrically conductive layer 34, the silver adhesive 52 is not in contact with the electrically conductive layer 34.

In the process as shown in FIG. 6A, the height of the coated silver adhesive for example is not greater than the thickness of the color film substrate, and a distance between a center position of the silver adhesive on the first contact portion and the color film substrate can be greater than or equal to a half of a thickness of the color film substrate and less than or equal to the thickness of the color film substrate. By controlling the coating position of the silver adhesive and the coating amount of the silver adhesive appropriately, the silver adhesive can be in contact with the black matrix and not in contact with the electrically conductive layer. More specifically, since the distance between the center position of the silver adhesive on the first contact portion and the color film substrate is less than or equal to the thickness of the color film substrate, the silver adhesive can be in contact with the black matrix through self-flow of the silver adhesive under gravity. That is, the silver adhesive would not be too far from the color film substrate so as not to be in contact with the black matrix. Moreover, since the distance between the center position of the silver adhesive on the first contact portion and the color film substrate is greater than or equal to a half of the thickness of the color film substrate, an undesired contact between the silver adhesive and other structures (e.g., the electrically conductive layer comprised in the color film substrate) on the color film substrate can be prevented. That is, the silver adhesive would not be too close to the color film substrate so as to result in undesired contact.

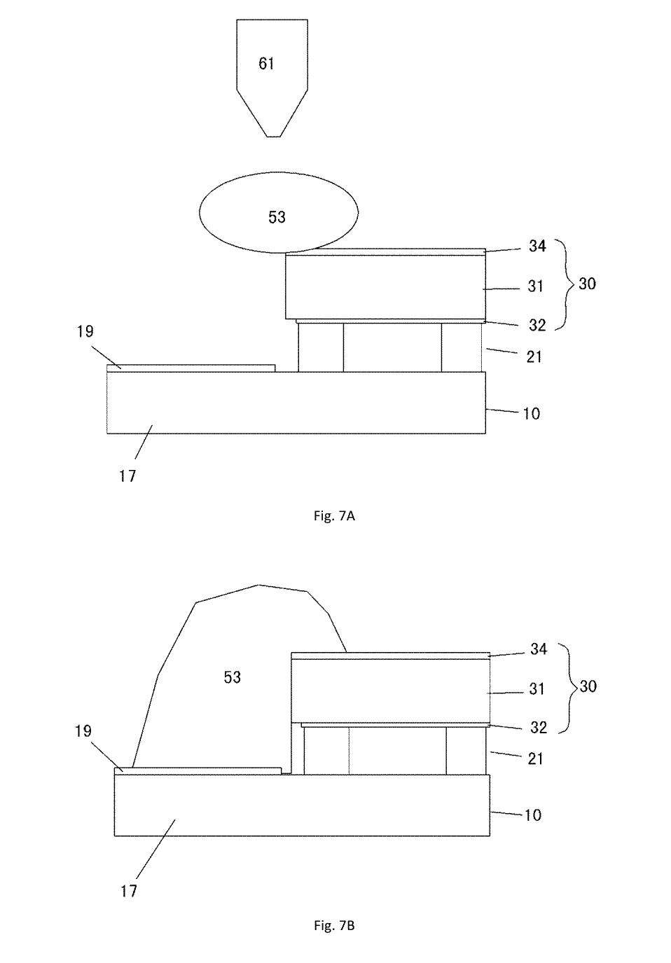

FIGS. 7A and 7B show exemplary processes of connecting the electrically conductive layer of the color film substrate to the second contact portion through the second electrically conductive member formed of the silver adhesive according to an embodiment of the present disclosure.

As shown in FIG. 7A, the silver adhesive 53 is coated on an edge of the color film substrate 30.

As shown in FIG. 7B, the electrically conductive layer 34 is connected to the second contact portion 19 through self-flow of the silver adhesive 53 under gravity, and the silver adhesive 53 is not in contact with the black matrix 32.

In order to enable the silver adhesive 53 not to be in contact with the black matrix 32, the portion of the edge of the black matrix 32 corresponding to the second contact portion 19 is closer to the sealant 21 than the edge of the base substrate 31 above the extending portion 17.

An embodiment of the present disclosure further provides a display device, which can comprise the above display panel.

In the display panel and the manufacturing method thereof as well as the display device according to embodiments of the present disclosure, since the black matrix is connected to the first contact portion through the first electrically conductive member and then is electrically connected to the common electrode layer, the potential of the black matrix can be the same as the potential of the common electrode layer. In this way, no electric field will be formed between the black matrix and the common electrode layer, which weakens or eliminates the flicker phenomenon and improves the quality of a display image.

Although exemplary embodiments of the present disclosure have been described in detail with reference to the drawings, such descriptions should be regarded as illustrative or exemplary rather than restrictive. The present disclosure is not limited to the disclosed embodiments. Different embodiments described above can also be combined. The skilled person in the art, when implementing the present disclosure, can understand and implement other variations of the disclosed embodiments based on studies on the drawings, description and claims. These variations also fall within a protection scope of the present disclosure.

In claims, the word “comprise” does not exclude presence of other components or steps. The mere fact that technical measures are stated in mutually different dependent claims does not mean that combination of these technical measures cannot be utilized advantageously.

1. A display panel, comprising:
an array substrate comprising a common electrode layer;
a color film substrate arranged opposite to the array substrate, the color film substrate comprising a base substrate and a black matrix on a surface of the base substrate opposite to the array substrate; and
a sealant arranged between the color film substrate and the array substrate,
wherein the array substrate further comprises an extending portion outside the sealant, a first contact portion for electrical connection with the common electrode layer is arranged on the extending portion, and the black matrix is connected to the first contact portion through a first electrically conductive member.

2. The display panel according to claim 1, wherein the first electrically conductive member is a silver adhesive.

3. The display panel according to claim 2, wherein the silver adhesive is located on the first contact portion, and a distance between a center position of the silver adhesive on the first contact portion and the color film substrate is greater than or equal to a half of a thickness of the color film substrate and less than or equal to the thickness of the color film substrate.

4. The display panel according to claim 1, wherein a portion of an edge of the black matrix corresponding to the first contact portion is aligned with an edge of the base substrate above the extending portion.

5. The display panel according to claim 1, wherein the color film substrate further comprises an electrically conductive layer located on a surface of the base substrate away from the array substrate, and the first electrically conductive member is not in contact with the electrically conductive layer.

6. The display panel according to claim 5, wherein a second contact portion for electrical connection with a ground wire is further arranged on the extending portion, the electrically conductive layer is connected to the second contact portion through a second electrically conductive member, and the second electrically conductive member is not in contact with the black matrix.

7. The display panel according to claim 6, wherein the second electrically conductive member is a silver adhesive.

8. The display panel according to claim 6, wherein a portion of an edge of the black matrix corresponding to the second contact portion is closer to the sealant than an edge of the base substrate above the extending portion.

9. A manufacturing method of a display panel, comprising:
forming an array substrate and a color film substrate, wherein the array substrate comprises a common electrode layer and an extending portion, a first contact portion for electrical connection with the common electrode layer is arranged on the extending portion, and the color film substrate comprises a base substrate and a black matrix on a surface of the base substrate;
attaching the color film substrate to the array substrate through a sealant so that the black matrix is opposite to the array substrate and the extending portion is located outside the sealant; and
connecting the black matrix to the first contact portion through a first electrically conductive member.

10. The manufacturing method of a display panel according to claim 9, wherein the first electrically conductive member is a silver adhesive.

11. The manufacturing method of a display panel according to claim 10, wherein connecting the black matrix to the first contact portion through the first electrically conductive member comprises:
coating the silver adhesive on the first contact portion; and
connecting the black matrix to the first contact portion through flow of the silver adhesive.

12. The manufacturing method of a display panel according to claim 11, wherein a distance between a center position of the silver adhesive on the first contact portion and the color film substrate is greater than or equal to a half of a thickness of the color film substrate and less than or equal to the thickness of the color film substrate.

13. The manufacturing method of a display panel according to claim 9, wherein a portion of an edge of the black matrix corresponding to the first contact portion is aligned with an edge of the base substrate above the extending portion.

14. The manufacturing method of a display panel according to claim 9, wherein the color film substrate further comprises an electrically conductive layer located on a surface of the base substrate away from the array substrate, and the first electrically conductive member is not in contact with the electrically conductive layer.

15. The manufacturing method of a display panel according to claim 14, wherein a second contact portion for electrical connection with a ground wire is further arranged on the extending portion, and the method further comprises:
connecting the electrically conductive layer to the second contact portion through a second electrically conductive member, wherein the second electrically conductive member is not in contact with the black matrix.

16. The manufacturing method of a display panel according to claim 15, wherein the second electrically conductive member is a silver adhesive.

17. The manufacturing method of a display panel according to claim 15, wherein a portion of an edge of the black matrix corresponding to the second contact portion is closer to the sealant than an edge of the base substrate above the extending portion.

18. A display device, comprising the display panel according to claim 1.

19. A display device, comprising the display panel according to claim 2.

20. A display device, comprising the display panel according to claim 3.
